(19) United States
(12) Patent Application Publication
(10) Pub. No.: US 2014/0287135 A1
(43) Pub. Date: Sep. 25, 2014

(54) METHOD FOR COATING NON-UNIFORM SUBSTRATES

(71) Applicant: XEROX CORPORATION, Norwalk, CT (US)

(72) Inventors: Edward B. Caruthers, Rochester, NY (US); Grace T. Brewington, Fairport, NY (US); Lalit Keshav Mestha, Fairport, NY (US)

(73) Assignee: Xerox Corporation, Norwalk, CT (US)

(21) Appl. No.: 13/849,114

(22) Filed: Mar. 22, 2013

(51) Int. Cl. B05D 7/00

(52) U.S. Cl. CPC B05D 7/586
USPC 427/10; 427/8

(57) ABSTRACT

A method for applying a uniform coating to a non-uniform substrate, the method including: a) optically characterizing the non-uniform substrate; b) adjusting a thickness and a color of a primer layer to achieve a first target color while depositing the primer layer on the non-uniform substrate; c) optically characterizing the non-uniform substrate comprising the primer layer deposited thereon; and, d) adjusting a thickness and a color of a first paint layer to achieve a second target color while depositing the first paint layer on the non-uniform substrate comprising the primer layer deposited thereon.

### INCORPORATION BY REFERENCE

The following issued patents are incorporated herein by reference in their entireties: U.S. Pat. Nos. 5,148,268; 5,277,762; 6,344,902 and, 6,947,175.

### TECHNICAL FIELD

The presently disclosed embodiments are directed to providing a system and method to decrease manufacturing costs for painted or coated non-uniform substrates with improved quality and color consistency, either within individual substrate pieces or within a group of substrate pieces.

### BACKGROUND

Non-uniform substrates present a variety of issues which preclude a homogeneous surface appearance. Examples of such non-uniform substrates include but are not limited to ceiling tiles, linoleum tiles and wood. Non-uniform substrates can have irregular surface textures and inconsistent color distribution. Moreover, some non-uniform substrates are constructed from an amalgamation of materials which each have unique colors, surface characteristics, etc.

Optically non-uniform substrates are typically coated with a primer, then at least one layer of colored paint and optionally a protective overcoat as a finishing step. A fixed painting process that can cover the most non-uniform substrates will use unnecessary paint when the same process is used on better substrates. In other words, non-uniform substrates require greater quantities of paint in order to achieve a consistent finished appearance, while more uniform substrates require lesser quantities of paint. Thus, as non-uniform substrates of varying quality are processed in a fixed painting or coating procedure, some substrates will receive too little paint, some substrates will receive the correct quantity of paint and other substrates will receive too much paint. Such a process cannot provide consistent painted or coated substrates and cannot optimize use of paint or coating materials, thereby resulting in wasted materials.

An apparatus and method are needed to minimize cost while maintaining the final color or surface appearance of a non-uniform substrate within an acceptable range. The present disclosure addresses a system and method which provide consistent, cost effective painting and/or coating of non-uniform substrates.

### SUMMARY

This present disclosure extends methods originally developed for color-controlled printing on paper to systems painting or coating optically irregular substrates such as ceiling tiles and the like. An embodiment includes the steps of: (1) optically characterizing an irregular substrate; (2) adjusting thickness and color of a primer layer to achieve a first target color; (3) optically characterizing the primer-coated substrate; and, (4) adjusting thickness and color of a paint layer to achieve a second target color. An embodiment may further include repeating steps (3) and (4) to apply a second paint layer. An embodiment may further include the steps of: (5) characterizing a gloss of the primed and painted substrate; and, (6) adjusting thickness and composition of an overcoat layer to achieve a target gloss. The relations used in the various control steps may be determined theoretically or empirically and may be further adjusted by a control system.

Broadly, the methods discussed infra provide method for applying a uniform coating to a non-uniform substrate. The method includes: a) optically measuring an initial surface characteristic set of the non-uniform substrate; b) calculating a primer coating parameter set based on the initial surface characteristic set; c) depositing a primer coating on the non-uniform substrate in accordance with the primer coating parameter set; and, d) curing the primer coating in accordance with the primer coating parameter set. In some embodiments, the present method further includes steps related to depositing a paint layer and depositing an overcoat layer.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a process diagram showing a prior art method of painting or coating a substrate;

FIG. 2 is a process diagram showing an embodiment of a present method of painting or coating a substrate; and,

FIG. 3 is an embodiment of a present system for painting or coating non-uniform substrates.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. it is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “optically non-uniform substrate” or “non-uniform substrate” is intended to be broadly construed as any substrate or set of substrates having inconsistent coloring, surface texturing or any other characteristic quantified by optical measurement means, e.g., colorimeter, spectrophotometer, reflectometer, etc. As used herein, “primer coating thickness profile”, “paint coating thickness profile” and “overcoat thickness profile” is intended to means the representation of the thickness of the respective material, i.e., primer coating, paint coating and overcoat, over the entire coated surface of the non-uniform substrate. Moreover, as used herein, “non-uniform thickness” is intended to mean a thickness of a material, e.g., primer coating, paint coating or overcoat, which has at least some irregularly to its thickness. As used herein, “primer curing profile”, “paint curing profile” and “overcoat curing profile” is intended to means the environmental characteristics need to cure a respective material, i.e., primer coating, paint coating and overcoat, such as heat, air flow, illumination levels and wavelengths, etc.

Furthermore, as used herein, the words “printer,” “printer system”, “printing system”, “printer device” and “printing device” as used herein encompasses any apparatus, such as a digital copier, bookmaking machine, facsimile machine, multi-function machine, etc. which performs a print outputting function fir any purpose. Additionally, as used herein, “sheet,” “sheet of paper” and “paper” refer to, for example, paper, transparencies, parchment, film, fabric, plastic, photo-finishing papers or other coated or non-coated substrate media in the form of a web upon which information or markings can be visualized and/or reproduced. Moreover, as used herein, “full width array” is intended to mean an array or plurality of arrays of photosensors having a length equal or greater than the width of the substrate to be coated, for example, similar to the full width array taught in U.S. Pat. No. 5,148,268. As used herein, the term ‘average’ shall be construed broadly to include any calculation in which a result datum or decision is obtained based on a plurality of input data, which can include but is not limited to, weighted averages, yes or no decisions based on rolling inputs, etc.

Moreover, although any methods, devices or materials similar or equivalent to those described herein can be used in the practice or testing of these embodiments, some embodiments of methods, devices, and materials are now described.

The production of many items begins with an optically non-uniform substrate. The substrate may be a natural product, such as wood, or it may be a composite material like the fiberboard described in U.S. Pat. No. 5,277,762. Optical variations may be in density, i.e., lighter and darker areas, or may be in color, i.e., regions of different hues. The final product may need to be of essentially constant color, such as a grey wall board or a white ceiling tile. In such cases a coating process must be used to hide the initial material variations. This may be done by using expensive materials with strong hiding power like rutile, i.e., TiO₂. Alternatively, hiding may be accomplished by applying multiple or thick coating layers. The final product will have target values for color and for uniformity, and the present disclosure sets forth a device capable of controlling and meeting such target values. Thus, the device of the present disclosure can control various coating steps to achieve the aforementioned target values, while using as little coating material as possible and using as little energy as possible, e.g., in the drying and curing steps.

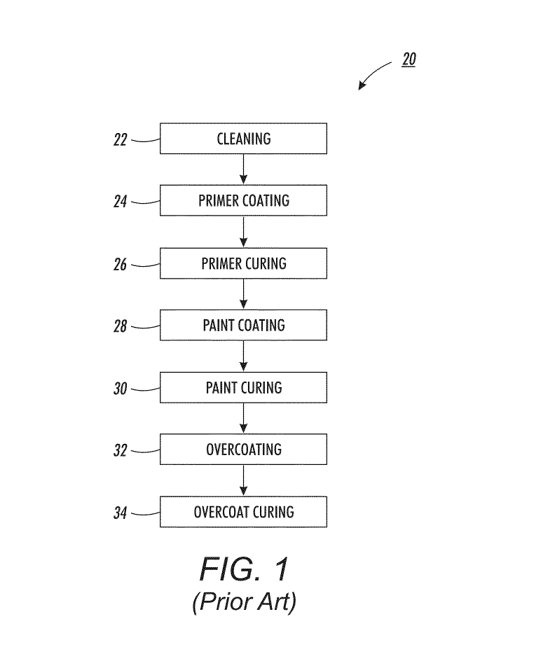

FIG. 1 depicts the steps in a typical, known painting process with fixed steps. Know process 20 comprises cleaning step 22 where a substrate to be coated is prepared for receipt of a primer coating. Primer coating step 24 includes the deposition of a primer coating layer on the cleaned substrate. Primer curing step 26 includes the curing of the primer coating layer, e.g., heat curing. Paint coating step 28 includes the deposition of a paint layer on the primer coating layer and is followed by paint curing step 30. Paint curing step 30 may be similar to primer curing step 26, i.e., may be a heat curing process; however, such process is dependent on the requirements of the particular paint material. Next, overcoating step 32 includes the deposition of an overcoat layer on the paint layer, followed by overcoat curing step 34 wherein the overcoat layer is cured in accordance with the overcoat layer requirements, e.g., heat or UV curing.

Each step of known process 20, i.e., cleaning, coating and curing, are always performed the same way and are not responsive to changes in the input substrate, i.e., the material being coated or painted. Variations in different process steps may occur intermittently; however, they occur independent of each other. Thus, such variations in the different process steps increase the total variations in the finished product.

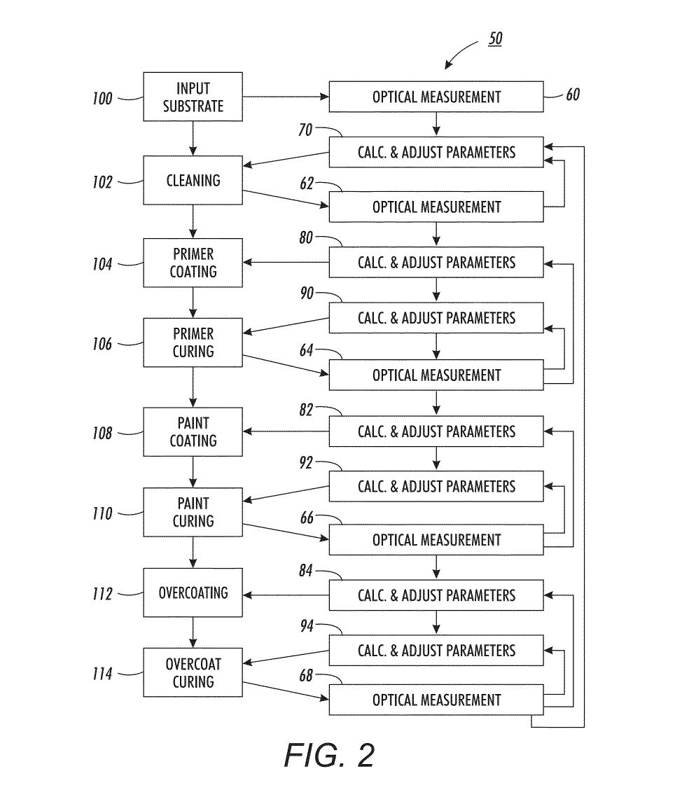

FIG. 2 depicts an embodiment of the present process for painting or coating a substrate using adjustable steps as described in greater detail herebelow. In this embodiment, each step of the process is adjusted to respond to variations in the incoming material. In this way, the quantity and color of each coating can be varied so that final color variations of the coated or painted substrate are kept within a target range while using minimum amounts of coating materials. Similarly, heat, air flow, illumination and other parameters in the curing steps may be varied so that each coating layer is fully cured using the least energy possible. The process depicted in FIG. 2 is described in greater detail infra.

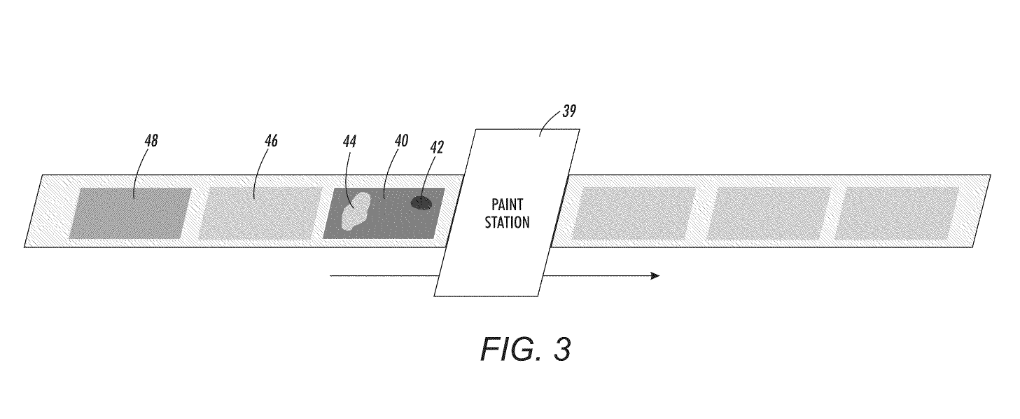

FIG. 3 depicts a present system for painting or coating non-uniform substrates having examples of optical density variations in ceiling tiles or other such materials entering painting station 39 in accordance with the disclosure herein. Substrate 40 has darker area 42 near its lead edge and lighter area 44 near its trail edge, substrate 46 is uniformly lighter than average, while substrate 48 is uniformly darker than average. It should be appreciated that “lead edge” is used to refer to the edge of a substrate that passes through a process step first, while “trial edge” is used to refer to the edge of a substrate that passes through a process step last. In an embodiment, the process varies only in the direction of travel of the substrates but not from side to side, while in other embodiments the process varies in a direction perpendicular to the direction of travel, and in still further embodiments the process varies in both directions. Some embodiments include optical sensing of these differences and active adjustment of the painting process, both from substrate to substrate and within a substrate. For example, the thickness of paint deposited may be greater than average for the first portion substrate 40, i.e., near dark area 42, average for the remaining portions of substrate 40, less than average for substrate 46, and greater than average for substrate 48. As previously described, in an embodiment, the process can also be varied from side to side, i.e., transverse to the process direction. For example, paint may be deposited by spraying a region smaller than the width of the substrate and that region may be swept side to side at a speed higher than the speed of the substrate in the process direction. In this embodiment, transverse variation in the incoming substrate may be measured and the process may be varied so that more or less paint is applied to darker or lighter patches, while nominal amounts of paint are applied on either side of the darker or lighter patches.

It should be appreciated that while the general principle of optimizing processes to minimize material and energy usage is well known, the present disclosure provides specific means appropriate for painting or coating optically non-uniform materials which have heretofore been unknown.

The following is best understood in view of coating process 50. In each of the optical measurement steps, 60, 62, 64, and 66, the output from the previous step is measured. Densitometers, scanning densitometers, sensor arrays, spectrophotometers, gloss meters and other optical sensors can be used in these steps. Furthermore, sensor arrays utilized in conventional printing systems may also be used in the foregoing optical measurement steps, e.g., full width LED arrays, small spot size sensors, raster scanners, etc. In an embodiment of steps 60, 62 and 64, the sensor outputs are analyzed to identify the darkest areas and the dominant hue of the incoming substrate. In an embodiment of step 66, the sensor output is analyzed to find the gloss and gloss variations of the incoming substrate. In an embodiment of step 68, the sensor measures and outputs the characteristics of the finished product. Any of the foregoing sensing steps may be virtual or with a virtual sensor obtained from models of the subsystem. It should be appreciated that any of the foregoing optical measurement steps may include the measurement of color, for example using the well known Lab (L*, a*, b*) color space, and may further include the measurement of gloss, for example using surface reflectivity at a particular angle of incidence.

In an embodiment of the cleaning parameter adjustment step 70, cleaning parameters such as fluid flow rate, abrasives content, sand paper grit, air flow, etc. may be adjusted in response to measured properties of the incoming substrate. For example, substrates with especially dark areas or especially large dark areas may be subjected to more aggressive cleaning in an effort to increase uniformity before the various coating and curing steps. If successful, this step may minimize the cost of coating materials and additionally minimize the energy required to cure the coatings.

In the coating parameter adjustment steps, 80 and 82, the thickness of the coating can be adjusted to just cover the darkest or most off-color regions of the incoming substrate. Thickness adjustment can be achieved, for example, by varying the air pressure in a spray gun, by varying nozzle settings, by varying electrostatic fields or by other means known in the art of painting and coating. Additionally, the hue of the coating material may be measured and adjusted to compensate for the hue of the input material. The measurement may be performed at the time the paint batch is prepared, or preferably, the paint may be continuously characterized, in case properties change during use, e.g., some components selectively settle and their concentrations decrease during use. In an embodiment, the hue adjustment may be done by selectively adding some of the components of the coating, such as different pigmented materials. Algorithms for adjusting the hue of the coating material in response to the hue of the substrate may be found theoretically, as described in U.S. Pat. No. 6,947,175, or the algorithms may be determined experimentally, for example by using well know techniques like statistically designed and analyzed experiments.

The foregoing coating parameter adjustment steps are substantially different from those known adjustments used in printing processes such as xerography, ink jet, offset and the like. In those known processes, the coating is typically the same, generally very thin and only the components are varied to control the final color. In the present method, the thickness and the color of each layer are simultaneously varied. Since final color results not only from the hue of a coating but also from its thickness, the control algorithm for this step is substantially different from those used in the color control of prints on paper. In other words, coating processes used for prints on paper result in uniform thicknesses of coating materials, while the present process results in variable thicknesses of coating materials.

In the coating parameter adjustment step 84, the amount of coating is adjusted based on the gloss of the incoming material so that the final target gloss is achieved. As in steps 80 and 82, the properties of the gloss may be measured either once per batch or continuously, and the composition of the gloss coating material may be adjusted.

In the curing parameter adjustment steps 90, 92 and 94, curing parameters such as air flow rates and air temperature are adjusted in response to the amount of coating applied in the previous step. In this way, each layer is fully cured without excessive energy being used. Continuous or periodic measurement of the curing process parameters, e.g., air flow rates, air temperature, etc., enable adjustment parameters, e.g., nozzle settings, heating rates, etc., to be adjusted to keep the curing process outputs at target values. As is known in the art, paint or coating curing can occur by use of heat, ultraviolet (UV) light, air flow, etc., which can result in the removal of solvent, i.e., drying, the cross-linking of the coating material, mechanical interpenetration, etc.

As can be appreciated when comparing FIGS. 1 and 2, the foregoing steps are used to modify known coating processes. For example, a substrate is introduced to the process at input step 100. The initial substrate is optically characterized in optical measurement step 60 which optical characterization data is provided to adjustment step 70. Adjustment step 70 controls cleaning step 102. Next the cleaned substrate is again optically characterized at optical measurement step 62 which optical characterization data is provided to adjustment steps 80 and 90. Adjustment step 80 controls primer coating step 104, while adjustment step 90 controls primer curing step 106. Then the primer coated substrate is again optically characterized at optical measurement step 64 which optical characterization data is provided to adjustment steps 82 and 92. Adjustment step 82 controls paint coating step 108, while adjustment step 92 controls paint curing step 110. Last the paint coated substrate is again optically characterized at optical measurement step 66 which optical characterization data is provided to adjustment steps 84 and 94. Adjustment step 84 controls overcoating step 112, while adjustment step 94 controls overcoat curing step 114.

All of the above steps of the present method can be practiced in a continuous painting or coating process in which the input material or substrate moves at a constant or nearly constant speed through the various coating and curing steps. The optical measurements can be taken when the material is between stations, e.g., priming, painting and curing. The above steps can also be practiced in a batch painting or coating process in which the material or substrate is moved from one station to another and then remains stationary while a coating or curing step is accomplished. In such an embodiment, residence time may also be used as a control variable, e.g., coating thickness may increase with time in a coating station or curing may increase with time in a curing station. Furthermore, the optical measurements may be obtained using a hand held device.

A portion of the above described methods are known as feed forward in the general controls industry. That is, those portions use information about the material or substrate entering a process step to adjust the process step as the material arrives. For example, curing parameters such as temperature and curing time may be determined based on the quantity of material deposited and the type of that material. Thus, the curing parameters are fed forward based on the deposition conditions from the prior step. Furthermore, a portion of the above described methods are known as feedback in the controls industry. That is, the results of each step can be compared to the targets for that step, e.g., coming as setpoints, and differences can be used to adjust the way that step is performed. In the present method, properties of raw materials may change with time, e.g., the hiding power of a layer thickness, or may increase or decrease as the materials of that layer change. Alternatively, the hue of a particular mixture of two pigmented materials may change if the raw materials used to make the pigmented materials change, e.g., pigment materials obtained from different suppliers. Known methods for using feedback and feed forward to adjust the parameters in a time hierarchical control system are described in the technical paper titled “Control Advances in Production Printing and Publishing Systems” presented at IS&T's “The 20th International congress on Digital Printing Technologies (NIP20)”, Oct. 31-Nov. 5, 2004, and U.S. Pat. No. 6,344,902.

In a time hierarchical system, time hierarchy comes from the ‘reduction of complexity’ rule used to design complex control systems, which can transform the system to many simpler ones while preserving the overall performance goals. Each controller sees the controllers below it as a virtual body from which it obtains percepts and sends commands. In a control hierarchy the lower level controllers run faster than higher level loops, at higher measurement-actuation intervals, controlling a group of subsystem variables. They deliver a simpler view to higher-level controls. The higher level controls coordinate commands to subsystems at a much lower measurement-actuation interval. Terms like levels 1,2,3,4 controls may be used to describe the time hierarchy with ‘1’ to describe the lower level subsystem controls such as the ‘charge control’, ‘toner concentration control’, etc., ‘2’ to describe controls between subsystems; e.g., ‘charge and development’ systems, ‘3’ to describe image control for each separation tone adjustments, e.g., ID tone reproduction control, and ‘4’ to describe image control for between multiple separation tone adjustments, e.g., 3D profile control, to minimize the interactions between colorants which cause color shift in the output.

In the present painting control system for non-uniformly colored substrates, a similar time hierarchical control architecture in which feedbacks loops with controllers is incorporated at various levels which use a system wide view to provide feedbacks to various actuators included at each stage of the system, such as: cleaning parameter adjustment step 70, coating parameter adjustment step 80 and curing parameter adjustment step 90; coating parameter adjustment step 82 and curing parameter adjustment step 92; and, coating parameter adjustment step 84 and curing parameter adjustment step 94, at various times to result in increased overall performance. At level 1, sensed data from optical measurement step 62 can be used to obtain proper adjustment values to actuators in cleaning parameter adjustment step 70 when there is no feedforward present at cleaning parameter adjustment step 70. If feedforward is present, then the targets or setpoints to feedforward loop of cleaning parameter adjustment step 70 can be changed using sensed data from optical measurement step 62. Similarly, sensed data from optical measurement step 64 can be used to obtain proper adjustment values to coating parameter adjustment step 80 and curing parameter adjustment step 90 actuators, sensed data from optical measurement step 66 can be used to obtain proper adjustment values to coating parameter adjustment step 82 and curing parameter adjustment step 92 actuators, and sensed data from optical measurement step 68 can be used to obtain proper adjustment values to coating parameter adjustment step 84 and curing parameter adjustment step 94 actuators. The results of level 1 control will appear in the next step, giving rise to at least one process step delay. All the loops within a level 1 configuration can be executed in a sequential manner. In a level 2 configuration, the setpoints for one or more level 1 loops can be adjusted using measurements from an intermediate sensor or from the final finished product by the sensor optical measurement step 68. Also, a controls supervisor may be incorporated to adjust the setpoints to level 2 controls. It should be noted that the complexity of the controls hierarchy can be reduced by reducing the number of levels or the number of controllers at each level in order to reduce the implementation cost.

In view of the foregoing, it can be seen that lower level loops and higher level loops can be utilized individually or in combination, depending on system needs, to control the present coating system. For example, lower level loops can include the use of measurements obtained from optical measurement step 62 to affect parameter adjustment step 70. It can also include the use of measurements obtained from optical measurement step 64 to affect parameter adjustment step 80. An even higher level loop can include the use of measurements obtained from optical measurement step 68 to affect parameter adjustment step 70. The present disclosure is not limited to the foregoing examples, and other lower level loops and higher level loops are readily apparent in view of the disclosure above. Moreover, feedback from prior am measurements can also be used for the adjustment and control of subsequent runs, and such variations fall within the spirit and scope of the claims.

It should be appreciated that the foregoing embodiments can be used for making painted, coated and/or colored boards, panels, etc. for ceiling tiles, floor coverings, wall coverings, decorative items, or even fabrics. The foregoing disclosure sets forth using image sensors and a control system to optimize a painting or coating process. The sensors monitor input and output at each stage of the process, and adjust known parameters. The present embodiments minimize output variation and cost. Without the present control system, a uniform output can only be achieved by using thick layers of paint, which requires large amounts of material and energy to cure. With the present controls, the amount of paint is decreased for the majority of input substrates without affecting output quality. Moreover, the desired finished color can be controlled by mixing colors from a set of color, e.g., red, yellow and blue can be mixed to result in a variety of finished colors. Although the priming step typically involves the use of a white primary coating, other primer coating colors may be used too, e.g., a light blue primer coating could be used if the finished color is blue. Furthermore, the foregoing methods can be used in a fully automated real-time process system, i.e., inline, or may be used in a batch processing system, i.e., offline.

The present system and method for coating or painting a non-uniform substrate is substantially different than known systems and methods fir printing on conventional paper or other types of sheets. In particular, paper has a high quality and uniform surface for receipt of printed material. With respect to the well recognized color difference metric Delta E, high quality paper substrates typically have a Delta E value of 0.5, while lower quality paper substrates may have a Delta E value of approximately 1.0. Contrarily, non-uniform substrates such as ceiling tiles may have a Delta E value of more than 5.0, and in some circumstances may even include spotted regions of varying colors. Moreover, ceiling tiles may be tan in color, as opposed to the substantially white color of a typical paper substrate. In view of the foregoing, it should be appreciated that non-uniform substrates may require initial cleaning operations and/or additional paint or coating material to cover the non-uniform substrate's varying coloring. Conventional paper or sheet printing requires only dust removal with no other pre-cleaning processes. Non-uniform substrates such as ceiling tiles are often manufactured from a variety of materials which can include but are not limited to recycled materials. It should be appreciated that the variety of materials may result in not only differences in substrate coloring but also substrate texture, surface roughness and capacity to retain coating or painting materials. Furthermore, conventional paper printing occurs on sheets falling into generally standard size and color categories, while the non-uniform substrates of the present disclosure may come in a variety of sizes and colors, including as described above, color variation within a single piece of substrate. Furthermore, non-uniform substrates such as ceiling tiles have what is considered macro non-uniformity. Macro non-uniformity can take the form of holes and high roughness values. These characteristics may be specifically configured to make the tiles sound absorbing or provide a particular level of light reflectivity.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for applying a uniform coating to a non-uniform substrate, said method comprising:
a) optically measuring an initial surface characteristic set of the non-uniform substrate;
calculating a primer coating parameter set based on the initial surface characteristic set;
c) depositing a primer coating on the non-uniform substrate in accordance with the primer coating parameter set; and,
d) curing the primer coating in accordance with the primer coating parameter set.

2. The method of claim 1 wherein the primer coating parameter set comprises at least one of the following parameters: a primer coating thickness profile, a primer coating color, a primer coating material and combinations thereof.

3. The method of claim 1 wherein the primer coating parameter set comprises a primer coating thickness profile, the primer coating thickness profile comprises a non-uniform thickness.

4. The method of claim 1 further comprising:
e) optically measuring a primed surface characteristic set of the non-uniform substrate comprising the primer coating;
f) calculating a paint coating parameter set based on the primed surface characteristic set;
depositing a paint coating on the primer coating in accordance with the paint coating parameter set; and,
h) curing the paint coating in accordance with the paint coating parameter set.

5. The method of claim 4 wherein the paint coating parameter set comprises at least one of the following parameters: a paint coating thickness profile, a paint coating color, a paint coating material and combinations thereof.

6. The method of claim 4 wherein the paint coating parameter set comprises a paint coating thickness profile, the paint coating thickness profile comprises a non-uniform thickness.

7. The method of claim 4 further comprising:
i) optically measuring a painted surface characteristic set of the non-uniform substrate comprising the primer coating and the paint coating;
j) calculating an overcoat parameter set based on the painted surface characteristic set;
k) depositing an overcoat on the painted coating in accordance with the overcoat parameter set; and,
l) curing the overcoat in accordance with the overcoat parameter set.

8. The method of claim 7 wherein the overcoat parameter set comprises at least one of the following parameters: an overcoat thickness profile, an overcoat gloss, an overcoat material and combinations thereof.

9. The method of claim 7 wherein the overcoat parameter set comprises an overcoat thickness profile, the overcoat thickness profile comprises a non-uniform thickness.

10. The method of claim 7 wherein at least one of the initial surface characteristic set, the primed surface characteristic set and the painted surface characteristic set is used when calculating at least one the primer coating parameter set, the paint coating parameter set and the overcoat parameter set.

11. The method of claim 1 wherein the non-uniform substrate is selected from the group consisting of: a ceiling tile, a floor covering, a wall covering, a decorative item, a fabric, and combinations thereof.

12. A method for applying a uniform coating to a non-uniform substrate, said method comprising:
a) optically characterizing the non-uniform substrate;
adjusting a thickness and a color of a primer layer to achieve a first target color while depositing the primer layer on the non-uniform substrate;
c) optically characterizing the non-uniform substrate comprising the primer layer deposited thereon; and,
d) adjusting a thickness and a color of a first paint layer to achieve a second target color while depositing the first paint layer on the non-uniform substrate comprising the primer layer deposited thereon.

13. The method of claim 12 further comprising:
b1) adjusting a primer curing profile to achieve the first target color after depositing the primer layer on the non-uniform substrate; and,
d1) adjusting a first paint curing profile to achieve the second target color after depositing the first paint layer on the non-uniform substrate,
wherein step b1) occurs between steps b) and c) and step d1) occurs after step d).

14. The method of claim 12 further comprising:
e) optically characterizing the non-uniform substrate comprising the primer layer and the first paint layer deposited thereon; and,
f) adjusting a thickness and a color of a second paint layer to achieve a third target color while depositing the second paint layer on the non-uniform substrate comprising the primer layer and the first paint layer deposited thereon.

15. The method of claim 14 further comprising:
f1) adjusting a second paint curing profile to achieve the third target color after depositing the second paint layer on the non-uniform substrate,
wherein step f1) occurs after step f).

16. The method of claim 12 further comprising:
e) optically characterizing the non-uniform substrate comprising the primer layer and the first paint layer deposited thereon; and,
f) adjusting a thickness and a composition of an overcoat layer to achieve a target gloss while depositing the overcoat layer on the non-uniform substrate comprising the primer layer and the first paint layer deposited thereon.

17. The method of claim 16 further comprising:
f1) adjusting an overcoat curing profile to achieve the target gloss after depositing the overcoat layer on the non-uniform substrate,
wherein step f1) occurs after step f).

18. The method of claim 12 wherein the non-uniform substrate is selected from the group consisting of: a ceiling tile, a floor covering, a wall covering, a decorative item, a fabric, and combinations thereof.
